(19) United States
(12) Patent Application Publication
(10) Pub. No.: US 2008/0237260 A1
(43) Pub. Date: Oct. 2, 2008

(54) Beverage Dispenser and Sealed Dispensing unit

(76) Inventor: Paul Leon Wolek, Hobart, IN (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/867,521

(22) Filed: Oct. 4, 2007

Related U.S. Application Data
(60) Provisional application No. 60/828,149, filed on Oct. 4, 2006.

(51) Int. Cl. B65D 35/56; F25D 3/08; B67D 5/62; B67D 5/06

(52) U.S. Cl. 222/105; 62/457.2; 222/185.1; 222/146.6

(57) ABSTRACT

The invention described herein is a beverage cooler, equipped with an external valve or spigot in fluid communication with an internal bag or bladder, the bladder containing the beverage to be dispensed. The bag is typically connected to the external spigot by a length of hose or other conduit. The bag or bladder includes a fitting, and the hose includes a complimentary fitting that allows the bag to be attached to the conduit for dispensing of the beverage, and subsequent removal from the conduit or hose when the bladder is empty. Once the bag is connected, ice can be placed in the cooler to keep the beverage cold.

### RELATED APPLICATIONS

This application claims priority to provisional application 60/828,149 filed on Oct. 4, 2006, the contents of which is incorporated by reference in its entirety.

### FIELD OF INVENTION

This invention is related to beverage dispensers and coolers.

### BACKGROUND

The use of coolers and other beverage dispensers to provide cool refreshing beverages to thirsty individuals are well known in the art. Perhaps most well known or most publicized are the Gatorade® coolers used by celebratory professional and amateur athletes to douse the winning coach in a shower of ice cold, sugary isotonic sports drink. Such coolers are also deployed within factories to provide hydration for workers. Such coolers are also deployed in the field on utility trucks and can also be found at various points on golf courses.

While the beverage cooler is well known, it is not without its problems. Typically, the lids on such coolers, are not secured in any fashion. Thus, it is easy for someone with ill intent in mind, to tamper with or otherwise spike the drink contained within the cooler, with an undesirable substance. Sanitation can also become a concern. Such coolers need to be emptied and cleaned periodically to prevent the growth of mold, bacteria and other unsanitary conditions. Similarly, if the beverage in the cooler is not used within a specific period of time, the beverage must be disposed of, before preparing a new batch of drink within the cooler. One, of course, could continually add ice to the cooler, in order to preserve the beverage contained therein, however, the addition of ice may simply dilute the beverage to an undesirable level. Such dilution can affect the taste, and in the case of an isotonic beverage, the performance thereof.

### SUMMARY OF THE INVENTION

The invention described herein is a beverage cooler, equipped with an external spigot in fluid communication with an internal bag or bladder, the bladder containing the beverage to be dispensed. The bag is typically connected to the external spigot by a length of hose or other conduit. The bag or bladder includes a fitting, and the hose includes a complimentary fitting that allows the bag to be attached to the conduit for dispensing of the beverage, and subsequent removal from the conduit or hose when the bladder is empty. Once the bag is connected, ice can be placed in the cooler to keep the beverage cold. Such a system eliminates waste, as ice can continually be added to the cooler to keep the beverage cold and preserved. Since the bag or bladder does not include a vent and remains sealed, air does not enter the bladder and thus preventing contaminating or providing oxygen to the contents therein.

One skilled in the art can readily see that such an apparatus can be provided to convert an existing cooler to the present system. Such conversion kit would include a spigot to be placed through the wall of a cooler, a flanged fitting to secure the spigot into the wall and provide an attachment point for a hose. The opposite end of the hose would include a detachable fitting for connection to a fitting on the bladder or bag. One skilled in the art will also recognize that the fittings for attaching the hose to the spigot can vary. Conceivably, the fitting could be a barbed fitting that could fit into the hole for the existing spigot in the standard cooler.

A further improvement on the system, is to provide a spigot that is flexible, as it is often complained of, especially in the utility truck market, that the spigot is exposed and gets broken off of the side of the cooler, thus rendering the cooler useless. Such a flexible spigot can include a length of flexible hose connected to the external wall of the cooler and being in fluid communication with the hose that leads to the bladder, the external hose could then be connected to a valve, spigot, or other device to selectively control the flow of fluid. Since the hose is flexible, knocking or other movement of the valve should not dislodge or damage the valve, but rather the hose should flex to allow the valve to remain undamaged.

### BRIEF DESCRIPTION OF THE DRAWINGS

FIG. 1 is a perspective view of a cooler having a lid and spigot.

FIG. 2 is a cross sectional view of the cooler of FIG. 1 showing a bladder and ice in the cooler.

FIG. 2a is a view of an alternate embodiment of a valve assembly including a flexible section of hose.

FIG. 3 is a top view of a cooler with the lid off showing a bladder being connected to the hose end fitting.

FIG. 4 is a top view of a cooler with the lid off showing a bladder connected to the hose end fitting.

FIG. 5 illustrates a coiled hose for use with the invention.

### DETAILED DESCRIPTION OF THE PREFERRED EMBODIMENT

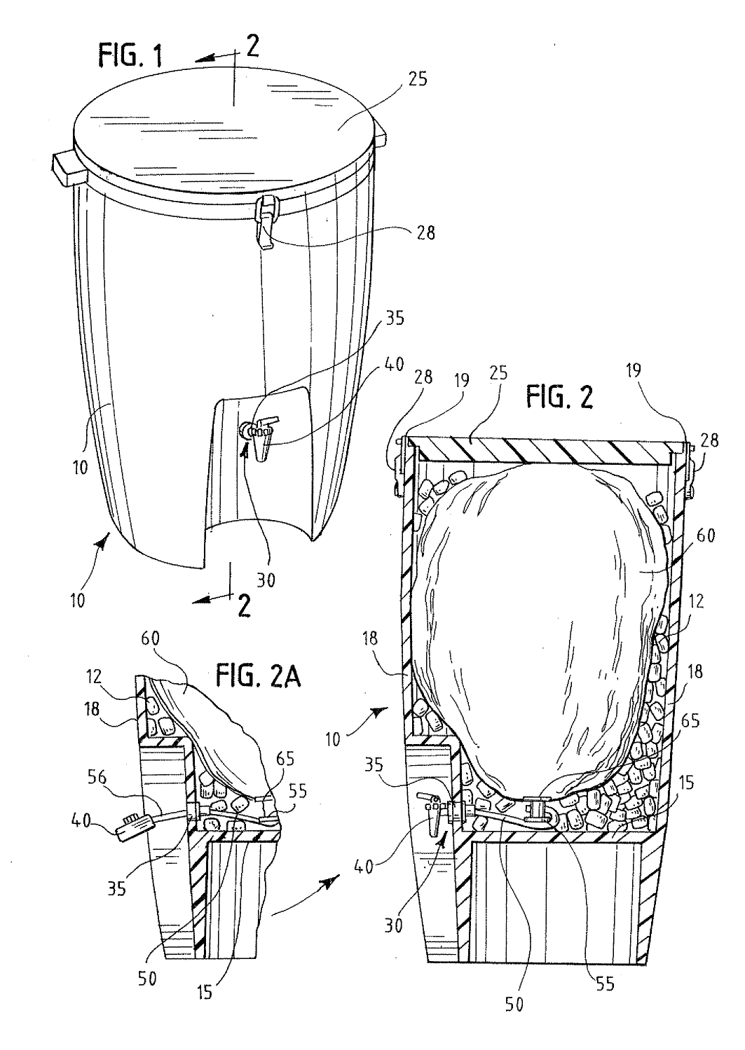

As shown in the figures, with particular reference to FIGS. 1 and 2, the cooler 10 disclosed herein includes a base 15 which is generally circular, and a wall 18 or walls extending upwardly therefrom to form a bucket or container. In the preferred embodiment, the walls 18 are cylindrical, but one skilled in the art will recognize that the walls can take any shape, so long as they form a container capable of holding ice 12. It is preferable that the walls 18 and base 15 are insulated, so that the contents inside can be maintained at a desired temperature, independent of the external environmental variables. The cooler 10 also contains a lid 25, which can be attached to the ends 19 of the walls 18 to form a closed container. As with the walls 18 and base 15, the lid 25 may also be insulated. The lid 25 can include a latch 28 or a plurality of latches to secure the lid 25 in place on top of the walls 18. Optionally, the cooler 10 may also include handles to allow easy transport.

The wall 18 or base 15 of the cooler further includes an aperture 30. The aperture 30 is occupied by a fitting 35 that allows communication from the interior of the cooler 10 to the exterior of the cooler. On the exterior side of the fitting, a valve 40 is attached. One skilled in the art will recognize that the valve 40 and fitting 35 may be formed as an integral unit. In the preferred embodiment, the fitting 35 is inserted into aperture 30 from the interior of the cooler 10 and the valve 40 is inserted from the exterior side. The parts have corresponding threads to allow the valve 40 and the fitting 35 to be secured together. The valve 40 may be a spigot or other structure that allows selective flow of fluid therefrom. The valve 40 is in fluid communication with a length of hose 50, conduit, piping or other structure that allows the communication of fluid from one end to another. On skilled in the art will recognize that there are many different arrangements to connect the hose 50 to the valve 40. At the opposite end of the hose 50 is a coupling or hose end fitting 55.

A further improvement on the system, is to provide a valve or external assembly that is flexible. As shown in FIGS. 2a, 3, and 4, a section of hose 56 connects the fitting 35 to a valve 40. The valve 40 may be rigid or flexible, since the section of hose provides flexibility. In other embodiments, the hose 50 may extend out of the aperture 30, thus eliminating the need for the section of hose 56.

The system further includes a bladder 60, bag or other structure to contain a beverage to be dispensed. The bladder 60 is typically constructed of aluminized PET film or other plastics. The bladder 60 includes a bladder fitting 65, which is complimentary to the hose end fitting 55 on the opposite end of the hose 50. Such complimentary fittings allow the hose end fitting 55 to be connected to the bag or bladder fitting 65 so that fluid can flow from the bag into the hose 50 and out the spigot. In the preferred embodiment the bladder fitting 65 includes a seal to prevent the flow of beverage until the bladder is connected to the hose end fitting 55. The hose end fitting 55 includes a structure to pierce the seal once the hose end fitting 55 is connected, thus allowing beverage to flow into the hose 50.

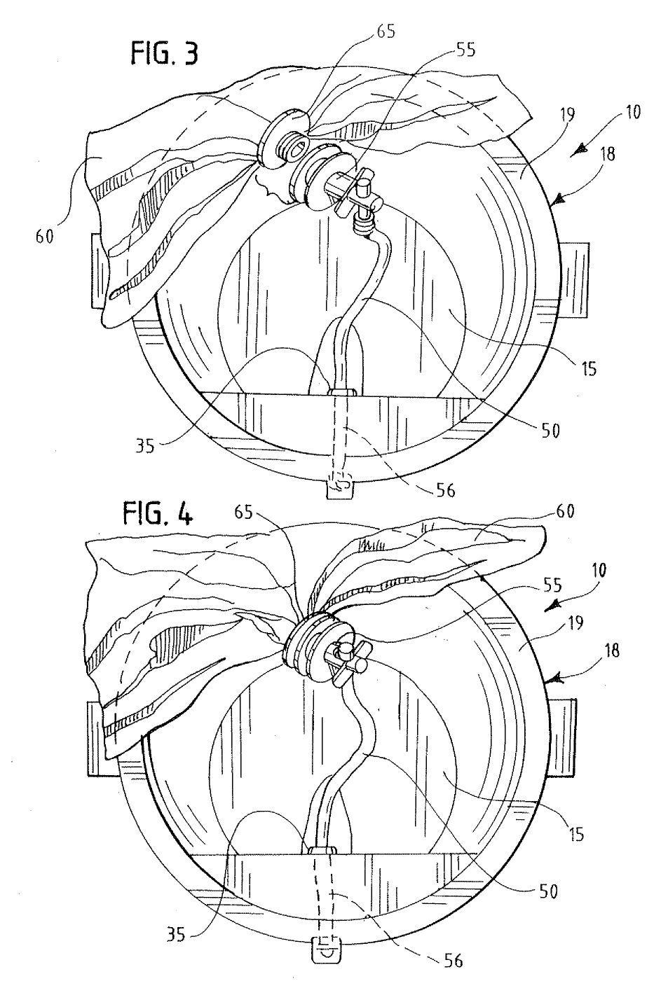

While the hose 50 can be of any length, it is preferred that the hose 50 is of sufficient length to extend to or near the upper edge 19 of the sidewalls 18 of the cooler 10. Such hose length allows the bladder 60 or bag to be draped over the top of the walls 18 of the cooler 10 with the bag or bladder fitting 65 extending slightly down into the cooler 10, as shown in FIGS. 3 and 4. Such placement allows for easy attachment of the hose 50 and bag end fitting 55 to the bag fitting 65. With such length or hose 50, the bladder 60 ma y be placed upon the upper ends 19 of the wall 18 for support so that the user does not have to support the bladder 60 while attaching the hose 50.

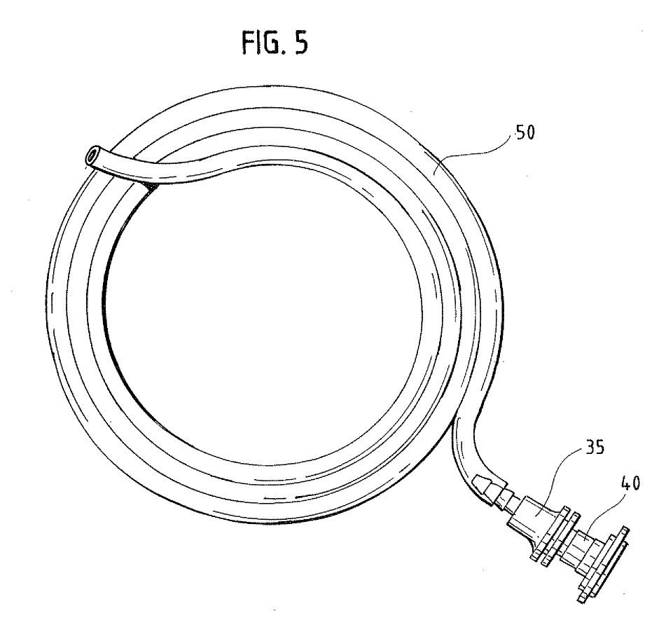

As shown in FIG. 5 without the hose end fitting 55, the hose 50 may be formed so as to retain a coiled shape. Such forming allows the hose 50 to be stretched out to allow for sufficient length for connection of the bladder 60, while also allowing the hose to spring back to a generally planar arrangement when the bladder 60 is placed in the cooler 10. A hose 50 so formed will then rest below the bladder 60 in the cooler 10. Such forming alleviates the user of the hassle of arranging the hose 50 in the cooler 10 each time a bladder is inserted into the cooler 10. Similarly, the hose 50 may be formed so that it forms a helical coil. Such arrangement also allows the hose to stretch out to a sufficient length for securing the bladder 60, and then retract to neatly fit into the cooler 10. In the helical arrangement, it is preferable that the hose 50 coil near the base 15, so the bladder may rest partially on top of the coils. In other embodiments, the bladder 60 may rest partially within the space between the coils of the hose 50

Once the fittings are attached, the bladder 60 is placed into the cooler 10 and the cooler is then filled with ice 12. The bladder 60 or bag, as well as the hose 50 and any fluid therein, are thus maintained at a cool temperature by the ice 12.

To ensure full flow of the beverage to be dispensed, it is preferable that the spigot 40 or valve be located at or near the base 15 of the cooler 10. This allows gravity to permit flow of fluid out of the spigot 40 if the bladder 60 sinks to the bottom of the cooler 10.

One skilled in the art will recognize that many types of connections can be used to connect the fluid transport components of the invention.

1. A beverage cooler in combination with a bladder for dispensing a beverage, the cooler having a base and upstanding walls, the base and walls forming a container for holding ice, an aperture near the base of the cooler, the aperture having a fitting for connecting a hose, the hose connecting the fitting and the bladder so as to allow the communication of fluid from the bladder to the fitting, the fitting being in fluid communication with a valve.

2. The beverage cooler of claim 1, wherein the hose is formed in a coil.

3. The beverage cooler of claim 1, wherein a section of flexible hose is located between the fitting and the valve.

4. The beverage cooler of claim 1, wherein the bladder is a sealed bladder.

5. The beverage cooler of claim 1, wherein the hose has a hose end fitting and the bladder has a bladder fitting, the hose and fitting and bladder end fitting connecting to allow fluid to flow from the bladder to the hose.

6. The beverage cooler of claim 1 wherein the hose is of sufficient length to reach the top of the upstanding walls.

7. A beverage dispensing system including a cooler having a base connected to upstanding walls, the base and wall forming a container having an interior and an exterior, a bladder located in the interior of the container, a valve located exterior of the container, a hose for communicating fluid from the bladder to the valve wherein the hose is coiled and located between the bladder and the base.

8. A fluid dispensing system for use with a cooler, the cooler having a base and walls, the base and walls defining a container for holding a fluid, the container having a valve to allow communication of fluid from the container, the system including a bladder for holding a fluid, and a hose connected to the bladder and to the valve.

9. The fluid dispensing system of claim 8, wherein the fluid in the bladder is cooled by ice.

10. The fluid dispensing system of claim 8, wherein the hose is formed in a coil.
